(19) United States
(12) Patent Application Publication
(10) Pub. No.: US 2005/0018885 A1
(43) Pub. Date: Jan. 27, 2005

(54) System and method of anatomical modeling

(76) Inventors: Xuesong Chen, Singapore (SG); Chee Kong Chui, Singapore (SG); Wieslaw T. Nowinski, Singapore (SG)

Correspondence Address: OSTROLENK FABER GERB & SOFFEN, 1180 AVENUE OF THE AMERICAS, NEW YORK, NY, 100368403, US

(21) Appl. No.: 10/479,402

(22) PCT Filed: May 31, 2001
(86) PCT No.: PCT/SG01/00111

(51) Int. Cl. G06K 9/00; G06T 17/10

(52) U.S. Cl. 382/128; 382/130

(57) ABSTRACT

Methods of modeling anatomical structures, along with pathology including the vasculature, spine and internal organs, for visualization and manipulation in simulation systems. A representation of on the human vascular network is built up from medical images and a geometrical model produced therefrom by extracting topological and geometrical information. The model is constructed using topological and geometrical information. The model is constructed using segments containing topology structure information, flow domain information contour domain information and skeletal domain information. A realistic surface is then applied to the geometric model, by generating a trajectory along a central axis of the geometric model, conducting moving trihedron modeling along the generated trajectory and then creating a sweeping surface along the trajectory. A novel joint reconstruction approach is also proposed whereby a part surface sweeping operation is performed across branches of the joint and then a surface created over the resultatn holes therebetween. A 3-D mesh may also be generated, based upon this model, for finite element analysis and pathology creation.

### FIELD

The present invention relates to anatomical and pathological modeling as utilised in virtual reality simulation environments, scientific visualization, computer aided geometric design and finite element analysis. More particularly the present invention relates to human anatomical and pathological modeling for visualization and manipulation in surgical simulation systems such as for the purposes of surgery planning, training and education.

### BACKGROUND

Medical simulators have significant potential in reducing the cost of health care through improved training and better pretreatment planning. Further, image guided procedures, such as vascular catheterization, angioplasty and stent placement are especially suited for simulation because it is possible to place the physician at a distance from the operative site, thereby remotely manipulating surgical instruments and viewing the procedure on video monitors.

For real-time and useful simulation of interventional procedures, such as catheterization, vasculature within the environment should be properly manipulated and accurately visualized. A geometric model can provide good support to these functions. In general, this requires the segmentation of topological and geometrical information from medical images before constructing a geometric model of the vasculature.

In surgical simulation applications, there are several methods of geometrical modeling for visualization and manipulation. These methods can generally be divided into two types. One type builds the geometrical model up directly from original image data. This can provide an accurate representation of the anatomical structure, but the model is usually intended for specific cases and cannot be applied generally. Further, processing the three-dimensional data directly from original medial images, such as medical resonance images (MRI), computerized tomography (CT) or ultrasound scan images, is computationally demanding. For example a 512×512×64×16 bit magnetic resonance angiogram is 32 MB. This size will prohibit the implementation in real-time.

The other type extracts or segments the topological and geometrical information first, then builds up the geometrical modeling from the segmented result. In this regard, it is to be appreciated that the topological information specifies vertices, edges and faces and indicates their incidence and connectivity, while the geometry specifies the equations of the surface and orientation.

One way to create an object is by utilising Constructive Solid Geometry (CSG). The CSG method utilises boolean operations to construct a logical binary tree of the primitives such as spheres and cylinders, in order to represent an object by its topological and geometrical description. In this regard, the technique represents a solid 3-D object by a functional definition identifying the set of points that lie within the object. For example, the object may be defined by a Boolean function which returns a “true” if applied to a point within the object and returns a “false” otherwise. Boolean operations for medical objects, however, are not particularly meaningful.

An alternative approach is that of boundary representations (B-reps). B-reps, explicitly describe the adjacency relationship of object topology and the hierarchical structure of the object geometry. An example of a B-reps based modeling system is BUILD developed by a CAD group at the University of Cambridge. This system produces a wing-edged data structure, which is a primary example of edge-based boundary models.

A problem with boundary representations is that they are usually computationally expensive. For instance, the ability to compute the intersection of two surfaces usually forms the heart of a solid modeling system. Hence, the internal or core representation may significantly influence the efficiency of computation and storage for tasks like surface intersection and blending.

These prior methods generally work well in engineering drafting and manufacturing where interactive design is of utmost importance. However, they do have deficiencies, particularly in medical applications, where model reconstruction from various modalities of images is an important issue.

There is therefore a need for an improved approach for creating a virtual representation of an anatomical structure. There is also a need for creating improved building blocks for use in forming these anatomical-structures.

Another problem that needs to be addressed in geometrical modeling is that of surface reconstruction from cross-sections.

The cross-sections from the scanned medical image can be parallel or non-parallel. Based on the segmentation algorithm used, there are generally two types of extracted geometrical information, being cross-contours on each slice (i.e. parallel cross contours) or cross contours that are perpendicular to the skeleton (i.e. non-parallel).

It has been found that a surface reconstructed from parallel cross-contours may not be good for visualization, especially if the central axis of the human vasculature is slanted with the slice. Further, if the scanned medical image includes different kinds of human anatomy, to date a suitable automated process for reconstructing the desired component of the image has not been developed.

Surface reconstruction may be volume based or surface based. Volume based reconstruction directly triangulates the set of points making up each of the cross sections, such that they become vertices of the surface mesh. The volume-based approach is difficult to use in cases where the cross-sectional shape varies between planes and where the cross sections are non-parallel. Further, it is difficult to constrain the aspect ratios of the generated triangles, since the vertices are defined by the positions of the cross sections. This can lead to poor quality surface displays if Gouraud shading is used. In this regard, much effort is also required to detect and correct special cases where the triangulation of complex shapes might otherwise fail.

Surface based reconstruction extracts the contours from the cross-sections and then connects the neighboring contours to form the surface. It can be applied to simple and complex shapes and can provide visually appealing results using computation geometry and graph theory. One problem with existing surface reconstruction methods, however is that they do not adequately allow branching junctions to be reconstructed. In this regard, the modeling of the branching junction is a challenging issue.

Therefore, an improved surface based reconstruction approach is required, in order to obtain a more general and complete solution for smooth surface reconstruction.

It is therefore an object of this invention to provide an improved surface based reconstruction approach as used in geometrical modeling. There is also a need for an improved surface reconstruction approach that can be used for both parallel and non-parallel cross-contours.

In medical simulation environments, meshes for Finite Element Modeling (FEM), which are generally used for enhanced realism in a virtual reality environment, can be generated using the reconstructed surface. FEM analysis is an essential method for deformation simulation. Hence, in such simulation environments, it is necessary to generate the FEM meshes of anatomical structures automatically. To date a mature FEM mesh generation model has not been developed for human anatomical structures, so an automatic modeling procedure is required in medical simulation environments.

It is therefore another object of this invention to provide a complete automatic FEM mesh generation method.

It is also an object of this invention to provide an improved geometrical model including information relating to pathology derived from medical images of specific patients.

### SUMMARY OF THE INVENTION

Overall the invention relates to geometrical modeling of anatomical structures for computer aided clinical applications, particularly in medical simulation environments.

According to one aspect, the present invention provides, in a biomedical simulation environment, a method of forming a visually continuous surface across a joint of a plurality of anatomical branches, the method including the steps of: generating surfaces for the anatomical branches using a part-surface sweeping operation; and constructing surfaces across any holes in the surface across the joint using a patch filling method to complete the joint surface.

In essence, this aspect of the invention allows information regarding the representation of the anatomical structure to be conveniently stored and compiled. It provides a solution for the problem of surface reconstruction from parallel-and non-parallel cross-sections with visually smooth surfaces rendered, wherein a novel joint construction approach deals with the difficult branching problem. The reconstructed geometrical surface allows visualization and manipulation flexibly performed, and the computational demand is within a standard PC.

According to a second aspect, the present invention proposes, in a biomedical simulation environment, a method of pathological modeling for use in the simulation of the growth of a pathology, the method including: creating a 3D surface model of the pathology; applying outward force at one or more surface points of the model; and calculating the degree of each force and the degree of deformation of the model at the one or more surface points as a result of each force.

According to a second aspect, the present invention provides, in a biomedical simulation environment, a method of pathological modeling for use in the simulation of the growth of a pathology, the method including: creating a 3D surface model of the pathology; and applying an appropriate filter to the model, the filter relating to the shape of the pathology being modeled.

According to a third aspect, the present invention provides, in a biomedical simulation environment, a method of interactive pathological modeling, the method including: obtaining angiographic observations relating to a pathology; extracting geometric parameter bounds relating to the pathology from the angiographic observations; incorporating the pathological parameters into a geometric anatomical model; and constructing a 3D anatomical model including the pathology from the geometric model such that the shape of the pathology is capable of modification by a user within the geometric parameter bounds.

In particular, the second and third aspects of the invention provide for pathology modeling in respect of vasculature. This aspect of the invention further allows models of pathology to be developed, which incorporate patient specific data, and hence are more suitable for and characteristic of patient specific applications.

According to a fourth aspect, the present invention provides, in a biomedical simulation environment, a method of automatically generating FEM mesh on a virtual anatomical object model for use in simulating deformation of at least a portion of the object, the model being formed from a plurality of cross-sections each having a plurality of points on the edges of the cross-sections with edge lengths between adjacent points on each cross-section, the method including the steps of: undertaking 2D mesh generation at each cross-section; undertaking 3D mesh generation between two adjacent cross sections by subdividing edge lengths of each cross-section to form one or more additional points and connecting corresponding points between adjacent cross-sections; and undertaking mesh refinement and/or optimization of the resultant 3D mesh.

According to a fifth aspect, the present invention provides a computer program product including a computer usable medium having computer readable program code and computer readable system code embodied on said medium for generating a mesh on a virtual geometric model for FEM analysis, the model formed from a plurality of cross-sections each having a plurality of points on the edges of the cross-sections with edge lengths between adjacent points on each cross-section, said computer program product further including computer readable code within said computer usable medium for: undertaking 2D mesh generation at each cross-section; undertaking 3D mesh generation between two adjacent cross sections by subdividing edge lengths of each cross-section to form one or more additional points and connecting corresponding points between adjacent cross-sections; and undertaking mesh refinement and/or optimization of the resultant 3D mesh.

According to a sixth aspect, the present invention provides a method of automatically generating a surface mesh on a object model for use in FEM analysis, the model being formed from a plurality of cross-sections each having a plurality of points on the edges of the cross-sections with edge lengths between adjacent points on each cross-section, the method including the steps of: undertaking 3D mesh generation between two adjacent cross sections by subdividing edge lengths of each cross-section to form one or more additional points and connecting corresponding points between adjacent cross-sections.

The fourth, fifth and sixth aspects of invention provide a general and complete FEM mesh generation method for anatomical structures from medical images. The 3D FEM mesh generation is also suitable for complex anatomy.

### BRIEF DESCRIPTION OF THE DRAWINGS

An illustrative embodiment of the invention will now be described with reference to the accompanying figures, in which:

FIG. 1 provides a diagram of the general procedure according to an embodiment of the invention, for effecting surgical simulation.

FIG. 2 illustrates a flowchart of a process according to an embodiment of the invention for creating a geometric model for medical simulation.

FIG. 3 illustrates an internal data structure for a segment used in creating a central axes model according to an embodiment of the present invention.

FIG. 4 provides a graphical indication of how a skeletal curve may be mathematically constructed in the surface reconstruction process.

FIG. 5 provides a graphical illustration of the mathematical generation of trajectories from a given triangle in regard to a branching model.

FIG. 6 illustrates sweeping surfaces applied along the trajectories calculated for the branching model of FIG. 5.

FIG. 7 illustrates part of the sweeping contours of FIG. 6.

FIG. 8 illustrates a two-dimensional Gaussian function with zero mean as used in pathological modeling.

FIG. 9 illustrates the growing of a pathological part, such as a tumour.

FIG. 10 illustrates a typical stenosis after agioplasty.

FIG. 11 illustrates a non-stented and a stented aneuryism model.

FIG. 12 illustrates the modeling of an aneurysm.

FIG. 13 illustrates a gridding scheme for use in FEM analysis according to an embodiment of the present invention.

FIG. 14 illustrates a flowchart of a validation process according to an embodiment of the invention.

FIG. 15 illustrates a pressure-radius curve for the canine carotid artery at degree of longitudinal extension (μ=1.8).

FIG. 16 illustrates constructed branch surface-with holes remaining in the joint modeling.

FIG. 17 illustrates the hole filling process in the joint modeling.

### DETAILED DESCRIPTION

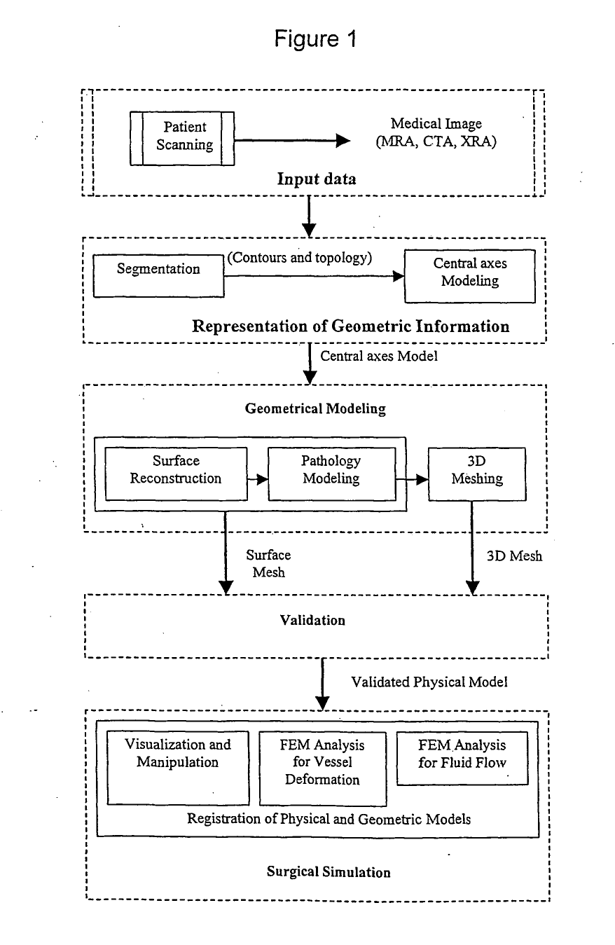

With reference to FIG. 1, a flow chart is provided which indicates the general steps taken in regard to creating a human anatomy model for surgical simulation.

The first stage is that of obtaining input data for creating the model. This may be achieved by scanning the relevant patient using, for example, MRI, CT, Ultrasound, X-ray rotational angiography (XRA) and obtaining the appropriate medical volume images therefrom.

It is also to be appreciated that where the present invention is being utilised in an operative situation, such as image-guided surgery, the input data may be a combination of pre-operatively acquired images and intra-operatively acquired images.

Once this input data has been obtained, the next stage is to derive a representation of the geometric information. Hence, the topological and geometrical information like contours, radii and central axes are extracted from the medical images. With this information segmentation is performed in order to obtain an appropriate representation, such as a Central Axes Model. In this regard, segmentation is required to extract and define objects of interest from the image data for anatomical differentiation and to create appropriate models.

There are various segmentation algorithms generally known in the art. Some algorithms are fully automated to extract the skeleton and radii of the human vasculature network, while others are semi automated and require some manual extraction, such as to extract contours from parallel cross-sections. The Central Axes Model that is derived is a representation of the geometric and topological information. A Central Axes Model is defined as one that consists of a sequence of line segments with each line segment being defined by a sequence of nodes, and at each node we define the cross section. The cross section can be parallel along the axis or at a tangent to the curvature of the line segment.

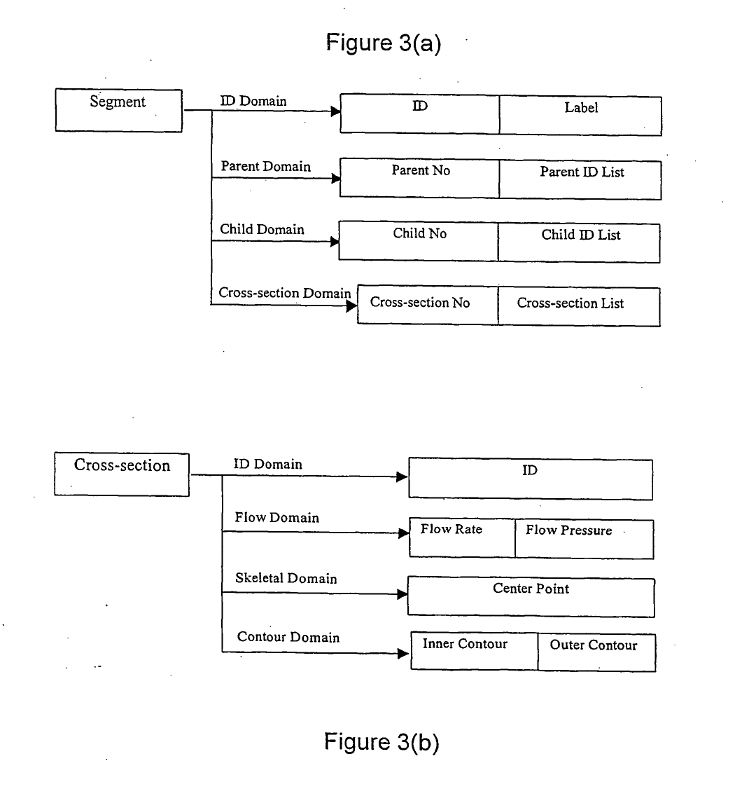

According to one embodiment of the invention, other information is stored in the model, including the topological relationship and fluid flow. In order to accommodate this addition information, this embodiment of the invention utilizes a multi-level representation of the central axes model, such as is illustrated in FIG. 3. Such a multi-level structural representation is useful not only in identifying the topological connectivity but also in describing vascular geometry, fluid and pathology. Therefore, a vascular system can be organized in the following structure of topology, geometry, mechanics and pathology.

With reference to FIG. 3(a), the topology is described using a tree structure representing a parent-child relationship between the vascular segments. A segment is the basic element of the vascular structure, and is characterised by its uniform ID and a label. A number of these segments will be included in a particular cross-section, which are similarly each characterised by a particular ID.

In this regard FIGS. 3(a) and (b) illustrate the internal data structure for the segment and cross-section structures of skeletal networks. The relative position of each segment is defined using a number of fields or domains, including the parent domain, the child domain and the cross-section domain. In the parent domain, the number of the segment's parent is listed, along with the ID list of that parent. Similarly in the child domain, there is a list of the segment's children, if any, and the respective Child ID lists. In the cross-section domain, the number of the cross section in which the segment is placed is included, as well as an indication of the cross-section list.

Similarly in the cross section structure, a number of fields or domains are provided, such as the flow domain, skeletal domain and a contour domain, which provide indications of vascular geometry, mechanics and pathology relating to the particular cross-sections.

Fluid flow, texture and material properties relate to vascular mechanics and information relating to these properties may be included in the cross-section domains.

Further, at the geometry level, blood vessels are described by their node coordinates, skeletal curves and visually-smoothed surfaces of segments and joints. There are-several different shapes of blood vessels, and hence different information is used to represent the blood vessels. For example, the cross-sections of circular-shaped blood vessels are generally represented with a centre point and radius. The cross-section of elliptic vessels is represented with a center point and the respective lengths of the major and minor axes as well as a vector showing the direction of the major axis. Hence, the appropriate information will be included in the skeletal domain, depending upon the type of blood vessel present in the vascular segment.

Pathological information can be represented as a combinatory function of topology, geometry and mechanics. In this regard, blood is a complex substance containing water, inorganic ions, proteins, and cells. The blood flow can be described reasonably accurately using the Newtonian assumption. Hence, in the flow domain, the flow rate and the flow pressure are preferably adopted. For example, in the aorta, the blood vessel has the flow rate of 80.00 ml/min while the left carotid has the flow rate 6.00 ml/min. FIG. 15 shows the pressure-radius curve for the carotid artery at a specific degree of longitudinal extension.

Further, the skeletal domain consists of a series of vertexes describing the center points of each cross-section, so the contour domain may be represented by the radii for each cross contour with circular or ellipse shape, and/or a number of dominant points at the edge.

From this topological and geometrical information, a geometrical model is then built up in order to obtain a visually detailed surface model to realistically display a human vascular network in the virtual environment. The geometric modeling process also enables a three-dimensional mesh model to be created, which may be used for FEM analysis during deformation modeling. Therefore, there are four components to this modeling:
1. Surface Reconstruction from parallel or non-parallel cross sections;
2. Pathological Modeling of various vascular pathologies;
3. Mesh generation for finite element analysis (FEM); and
4. Validation of the geometric model.
   1.0 Surface Reconstruction from Parallel or Non-Parallel Cross-Sections

Where a geometric model is created as the representation of geometric information, such as the Central Axis Model, the subsequent surface reconstruction process consists of two parts: segment reconstruction and joint reconstruction.

1.1 Segment Reconstruction

In the segment reconstruction, the trajectory of the central axis is first built, and then cross-contours are swept along the trajectory. In this regard the segments are positioned and ordered using the parent and child domains for each segment and the cross-contours created using, typically, this positional information and the contour domain information.

1.1.1 Curve Modeling.

For a vascular skeletal curve, desired features are:
1) Smoothness;
2) A low-degree complexity to take advantage of computational efficiency; and
3) Point interpolation to allow best shape preservation that is necessary when the curve is used as a path to construct a sweeping surface.

Given a discrete sequence of center points along each segment, a smooth skeletal curve can be obtained using curve modeling, such as by using the conventional B-spline method or the NURBS (Non-Uniform Rational B-Spline) method.

Another approach for creating reasonable visual smoothness is to create a cubic Bezier curve, which applies geometric continuity theory in order to create a visually smooth curve with piece-wise shape preservation.

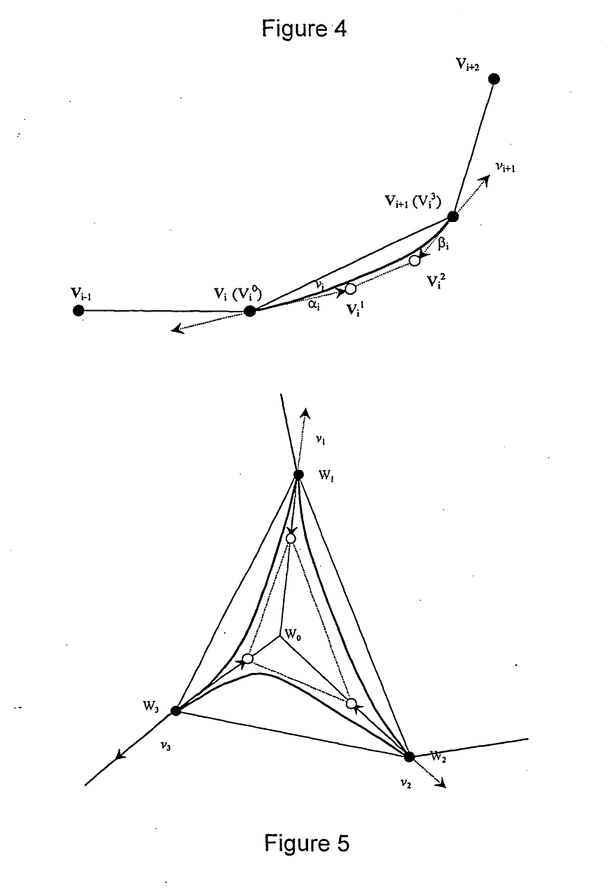

An example of how such a skeletal Bezier curve is constructed will now be described with reference to FIG. 4:

Step 1: compute unit difference vector at each node Vᵢ(i=0, . . . , n) by differencing the neighboring vertices. Each node has two node vectors in the forward or backward direction denoted as
vᵢ⁺=(Vᵢ₊₁−Vₗ)|∥Vᵢ₊₁−Vᵢ∥
, and
vᵢ⁻=(Vᵢ₋₁−Vₗ)/∥Vᵢ₋₁−Vᵢ∥.

Step 2: form the unit difference or tangent vector of vᵢ⁺ and vᵢ⁻,
vᵢ=(vᵢ⁺−vᵢ⁻)/∥vᵢ⁺−vᵢ⁻∥.

Step 3: generate inner control points Vᵢ¹ and Vᵢ² with parameters αᵢ and βᵢ,
Vᵢ¹=V_{i+α}ᵢvᵢ
, and
Vᵢ²=Vᵢ₊₁−βₗvᵢ₊₁
, where setting αᵢ=βᵢ=∥Vᵢ₊₁−Vᵢ∥/3.

Step 4: create the cubic Bezier curve with Vᵢ⁰=Vᵢ, Vᵢ¹, Vᵢ² and Vᵢ³=Vₗ₊₁
V(t)=Vᵢ⁰(1−t)³+3Vᵢ¹(1−t)²t+3Vᵢ² (1−t)t²+Vᵢ³t³.

For end points, given tangent vectors v₀ and vₙ are used. For the start vertex of root segment (no parent), v₀=v₀⁺/|v₀⁺|. For the end vertex of terminal segment (no child), vₙ=−vₙ⁻/∥vₙ⁻∥.

Clearly, V(t) passes through Vᵢ and Vᵢ₊₁ and is G¹ continuous or visually-smoothed over the curve. It can be used as a path to form a sweeping surface with a set of cross sections.

1.1.2 Surface Modeling

Surface modeling is a key step in surface reconstruction as it applies a sweeping operation along the skeletal curve.

So-called moving Frenet Frame is one approach used to develop the sweeping operation.

Let T, N, and B be the unit tangent, normal and binormal vectors of the curve at a given point, the triple turple (T, N, B) forms an orthogonal local coordinate system flowing along the curve. Generalized sweeping along the trajectory curve requires careful determination of the orientation if the governing curve is to be piece-wise defined. The binormal vectors along the central-curve may flip abruptly to the opposite direction at an inflection point; and the binormal vectors can rotate excessively around the tangent vectors, causing unwanted twisting of the resulting swept surface.

To minimise these problems, an alternative technique for generating a reasonably smooth trajectory is moving trihedron modeling, which will now be described:

1.1.2.1 Moving Trihedron Modeling

Let (Tᵢ⁰, Nᵢ⁰, Bᵢ⁰) be the trihedron at the start vertex with parameter t=0 of the ith piece-wise G¹ curve Vᵢ(t). The trihedrons (Tᵢ^{k}, Nᵢ^{k}, Bᵢ^{k}), k=1,2,3 (that is with parameters t=⅓, t=⅔ and t=1) are formed using an improved normal projection method. By projecting the previous Bᵢ^{k} onto the plane defined by Tₗ^{k+1} vector, a new vector Bᵢ^{k+1}=Bᵢ^{k}−(Bᵢ^{k}•Tᵢ^{k+1}) Tᵢ^{k+1} is obtained. The cross product vector of normalized Bᵢ^{k+1} and Tᵢ^{k+1} is assigned as the new Nᵢ^{k+1} to complete the new trihedrons (Tᵢ^{k+1}, Nᵢ^{k+1}, Bᵢ^{k+1}), k=0,1,2,3 for the current piece. With the two internal points (t=⅓ and t=⅔) joining the projection process, better smoothness for the new trihedrons can be achieved using this method. Note that (Tᵢ³, Nᵢ³, Bᵢ³) will be used in the next loop as the new start (Tᵢ₊₁⁰, Nᵢ₊₁⁰, Bᵢ₊₁⁰).

For elliptic-shaped vasculature, a local coordinate system is set up at each cross-section with the trihedron (Tᵢ, Nᵢ, Bᵢ) of the skeletal curve built above. Nᵢ, Bᵢ is equal to the X, Y axis of Cartesian Coordinate at each cross-section and Tᵢ is equal to the Z axis in three dimensional space.

Then the edge points of each cross-contour are constructed. The following shows the detailed procedure:
Step 1: +Compute the angle θ₀ between the local coordinate axis N and the vector v which describes the direction of the major axis.

$${θ}_{0} = arccos ( \frac{N \cdot ν}{\vert N \vert \cdot \vert ν \vert} ) ;$$

Note that the direction of the angle is from N to v, so if the cross product of N and v is opposite to T, that is, (N×v)•T<0, then
θ₀=−θ₀.
Step 2: Compute the edge points:
u(θ)=Vᵢ+a*Nᵢ*cos(θ−θ₀)+b*Bᵢ*sin(θ−θ₀), (0<θ<2π)
where V₁, is the center point of the cross-section; a and b are the lengths of the major axis and minor axis respectively.
Step 3: Generate intermediate points for Bezier curves between two adjacent cross-contours:
uᵢ¹(θ)=uᵢ⁰(θ)+αᵢTᵢ⁰,
uᵢ²(θ)=uᵢ³(θ)−βᵢ*Tᵢ³.
Thus, a sweeping surface is created by connecting the neighboring points at each cross-contour and the bezier curve between two adjacent cross-contours. The tangent vector Tᵢ^{k} (k=0,3) for all θ of the intermediate points has the advantage of producing tangential continuity at each cross-section.

In other words a smooth sweeping surface is preferably generated using a bi-cubic Bezier surface via piece-by-piece construction of a tangential continuous control net. That is, cubic Bezier control points are calculated along each cross contour at the local coordinate system in order to form a piecewise B-Spline curve.

Circular-shaped vasculature is a special case of the elliptic vasculature, in which a is equal to b. The reconstruction procedure is otherwise the same.

For the more general case, the cross-contour is represented with edge points, which are mapped onto the local coordinate system. If the cross-contour is represented with some dominant points, more points need to be interpolated in order to represent the edge of the contour accurately. The next step is same with step 3 above.

1.1.3 Automated Adaptive Resolution

When displaying human vasculature, one problem is representing the edge of the contour accurately. For example, in the central axes model, there is often much variation in distances between two adjacent nodes or cross-sections of human vasculature. In addition, the shape of the vasculature along the skeletal network usually varies. As a result, more detail in some places is required in order to obtain a higher resolution, while in other places lower resolution is required. In this regard, there is a relationship between the degree of resolution required and the degree of abrupt shape variance.

It is generally not sufficient to solve this problem by applying a fixed number of patches to the segment between every two adjacent cross-sections in Bezier curve generation, as this may result in the display resolutions being inconsistent for different parts of the vasculature. That is, the resolution may be low in some segments while unnecessarily high in other segments.

Therefore, to render the vasculature more visually uniform and reduce the computational demand, it is preferable to implement an automated-adaptive-resolution selection method.

In the automated adaptive resolution method, the bend of the segments indicating the shape variance is first computed as follows:
(a) Define a parameter: τ=Tᵢ•Tᵢ₊₁, where Ti is the normalized vector (Vᵢ−Vᵢ₋₁), and Tᵢ₊₁ is the normalized vector (Vᵢ₊₁−Vᵢ);
(b) If τ (0≦τ≦1) is smaller than a predefined threshold, then the resolution is increased between the segment from vᵢ₋₁ to vᵢ₊₁.
   The resolution for the vascular surface is decided by τ. If τ is small, it means that there is much bending of the vasculature, which requires the resolution to be higher in order to more accurately display the detail. With this method, the display of vasculature is improved, while also significantly reducing the number of the surface patches.
   1.2 Joint Reconstruction

In CAD/CAM applications, joints are typically created using boolean operations. This may involve modeling trimmed surfaces and blending. Usually this modeling is-computationally demanding, and the constructed surface lacks concrete description, which is required for manipulation operations in medical simulation environments.

According to an embodiment of the present invention, however, joints are reconstructed by using part of the surface sweeping operation to create the main branching surfaces, which connect the joint. The next step fills the corresponding triangle patches that are left.

1.2.1 Trajectory Modeling

FIG. 5 is an illustrative view showing the construction of a piecewise cubic Bezier curve for a three-way branching case. When such a branching case is located, trajectories through the vertices of each branch are firstly generated. In FIG. 5, three trajectories are generated from a given triangle of vertices W₁, W₂ and W₃. W₀ is an internal vertex in the triangle that has three branches characterized with vectors W₀W₁, W₀W₂ and W₀W₃. Let vector vᵢ (i=1,2,3) be the normalized branch vector, and three control polygons W₁U₁U₂W₂, W₂U₂U₃W₃ and W₃U₃U₁W₁ can be formed within the triangle. The determination of Uᵢ(i=1,2,3) is similar to the determination of Vᵢ^{1 and V}ᵢ², as discussed in relation to FIG. 4. Herein, v; is regarded as the tangent for the control polygons, hence Uᵢ lies at the line between Wᵢ and W₀, which is adjusted by the parameters αₗ and βᵢ. The calculations are as follows:

Step 1: compute the tangent vector at each vertex Wᵢ(i=1 . . . n) as:

for i=1 to n−1
   vᵢ=(W₀−Wᵢ)/∥W₀−Wᵢ∥
   , and
   vᵢ₊₁=(Wₗ₊₁−W₀)/∥Wₗ₊₁−W₀∥
and for i=n
   vᵢ=(W₀−Wᵢ)/∥W₀−Wᵢ∥
   , and
   v₁=(W₁−W₀)/∥W₁−W₀∥
   Step 2: determine control polygons, being for i=1 to n−1: Wᵢ Uᵢ Uᵢ₊₁ Wᵢ₊₁ and for i=n: WₙUₙU₁W₁
   Step 3: for i=1 to n−1, generate inner control points Uᵢ and Uᵢ₊₁ with parameters αᵢ and βᵢ,
   Uᵢ=Wᵢ+αᵢvᵢ
   , and
   Uᵢ₊₁=Wᵢ₊₁−βᵢvᵢ₊₁
   , where setting αᵢ=βᵢ=0.85*∥Wᵢ₊₁−Wᵢ∥. and for i=n, generate inner control points Uᵢ and U₁ with parameters αᵢ and βᵢ,
   Uᵢ=Wᵢ+αᵢvᵢ
   , and
   U₁=W₁−βₗv₁
   , where setting αᵢ=βi=0.85*∥W₁−Wᵢ∥.
   Step 5: create the cubic Bezier curve V(t) such that
   V(t)=Vᵢ⁰(1−t)³+3Vᵢ¹(1−t)²t+3 Vᵢ² (1−t)t²+Vᵢ³t³
   with, for i=1 to n−1: Vᵢ⁰=Wᵢ, Vᵢ¹=Uᵢ, Vᵢ²=Uᵢ₊₁, and Vᵢ³=Wᵢ₊₁ and for i=n: Vᵢ⁰=Wᵢ, Vᵢ¹=Uᵢ₊₁, Vᵢ²=Uᵢ₊₁ and Vᵢ³=W₁

Therefore the vectors vᵢ (i=1,2,3) are used as start tangent vectors to construct segment surfaces for corresponding branches. In this regard, the sharing of a tangent vector vᵢ with the Bezier curve just constructed and the start/end Bezier piece of the corresponding branch segment leads to a visual smoothness of the trajectories, αₗ and βₗ may be adjusted between ⅔and 1, which make small control adjustments to the joint reconstruction.

1.2.2 Surface Modeling

With the trajectories available, the surface sweeping operation can be performed. The procedure described in the previous section 1.1.2 for segment tube modeling is applied. The difference is that here the surface sweeping is performed with part of the appropriate cross-contours. The cross-contour at the start cross-section is divided into several portions according to the number of branches, then the corresponding part of cross-contour is swept along the branch trajectory. With this procedure performed for each branch, the main branch surface of the joint is formed. An important concern here is how to determine the part of surface, which is detailed below.

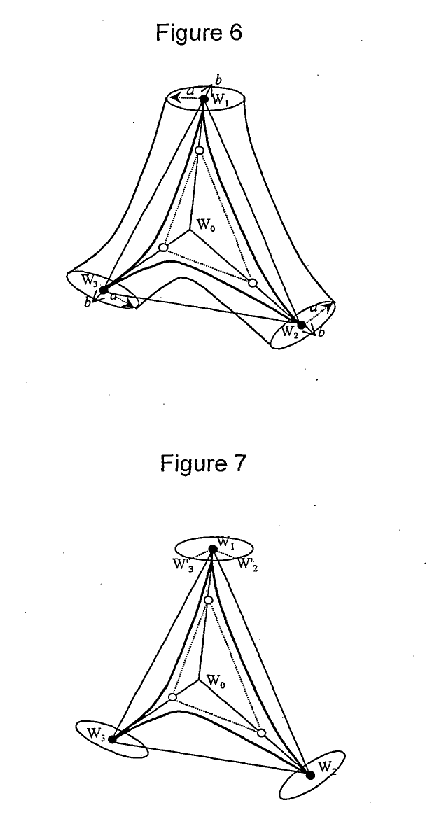

In FIG. 7, at the cross-contour containing W₁, W₂′ and W₃′ are the projections of the trajectories W₁U₁U₂W₂, W₂U₂U₃W₃ at the plane respectively. The line dividing ∠W₂′W1W₃′ will divide the W₁ cross-contour equally into two parts, and hence form two half-surfaces to be swept. The same principle will apply to the other two cross-contours and, once swept, corresponding half surfaces from neighbouring vertices will-merge. Hence, considering the FIG. 7 example, three half surfaces will result, extending from W₁ to W₂, from W₁ to W₃ and from W₂ to W₃. These merged half-surfaces are termed Bezier patches.

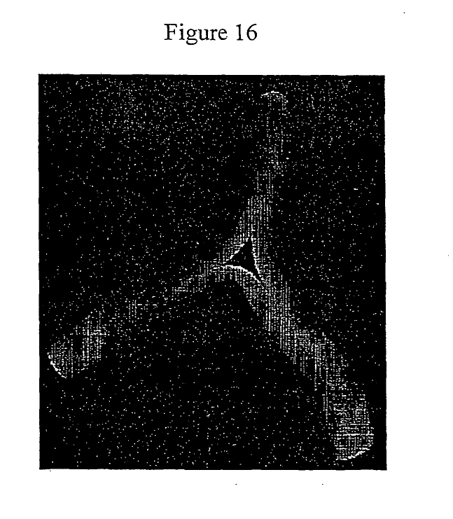

When the sweeping of the half-surfaces for FIG. 7 is completed, a branched structure will result as shown in FIG. 6. More specifically, this branched structure will have front and back holes, which are shown in FIG. 16.

Next, the front and back holes surrounded by the three Bezier patches (half-surfaces) need to be filled. Techniques for filling an n-sided hole are known. However, according to an embodiment of the present invention, an improved method to form a complete junction surface with visual continuity will now be described. This aspect of the invention can be used for multi-branching joints in the same method, but the case will be more complex. Further, it is apparent that this approach can be implemented on structures with multiple branches and hence addresses the branching junction problem. This method can be applied to general cases of other human anatomies, although it will now be described in relation to vascular tubular modeling. In addition, the branching modeling can be used for various kinds of joint design.

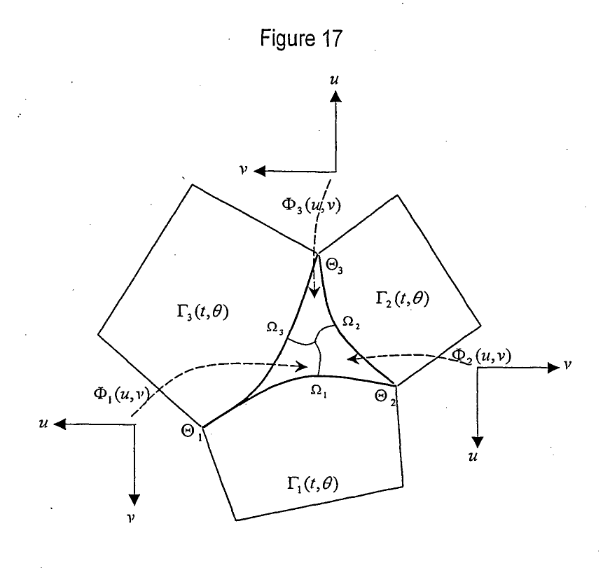

The method is performed using boundary continuity theory. The first step is to split each Bezier curve of each branch surface at the boundary with the hole into two at the center point with parameter t=0.5. With a center vertex assumed in the center of the hole, the hole is divided into three sub-patches, shown as FIG. 17. Let Γᵢ(t,θ) (i=1,2,3) be the three Bezier patches surrounding the front hole and Θᵢ(i=1,2,3) be three corner points, we wish to fill the triangular hole with three bicubic Bezier patches Φᵢ(u,v),(i=1,2,3), which adjoin the regular rectangular patch complex with parameterization as shown in FIG. 17.

In the boundary continuity theory, it is assumed the three sub-patches are continuous with their surrounding Bezier surface patches in zero-order and first-order. Thus Φᵢ(s,1) and Φᵢ₊₁(1,s) must match edge and cross-boundary tangent conditions of the i-th boundary. Hence the vertex data of these two patches along the common edge of the hole are identified with those of the surrounding bi-cubic patches.

$$\begin{matrix}Denote \\ {Ω}_{i} = {Φ}_{i} ( 0 , 1 ) = {Φ}_{i + 1} ( 1 , 0 ) \\ {Ω}_{i}^{u} = \frac{\partial {Φ}_{i} ( u , v )}{\partial u} {\vert}_{{u = 0}_{v = 1}} = \frac{\partial {Φ}_{i + 1} ( u , v )}{\partial v} {\vert}_{{u = 1}_{v = 0}} \\ {Ω}_{i}^{v} = \frac{\partial {Φ}_{i} ( u , v )}{\partial v} {\vert}_{{u = 0}_{v = 1}} = \frac{\partial {Φ}_{i + 1} ( u , v )}{\partial u} {\vert}_{{u = 1}_{v = 0}} \\ {Ω}_{i}^{u , v} = \frac{{\partial }^{2} {Φ}_{i} ( u , v )}{\partial u \partial v} {\vert}_{{u = 0}_{v = 1}} = \frac{{\partial }^{2} {Φ}_{i + 1} ( u , v )}{\partial u \partial v} {\vert}_{{u = 1}_{v = 0}} \\ Λ = {Φ}_{i} ( 0 , 0 ) \\ {Λ}_{i} = \frac{\partial {Φ}_{i} ( u , v )}{\partial v} {\vert}_{{u = 0}_{v = 0}} = \frac{\partial {Φ}_{i + 1} ( u , v )}{\partial u} {\vert}_{{u = 0}_{v = 0}} \\ {Λ}_{i , i + 1} = \frac{{\partial }^{2} {Φ}_{i} ( u , v )}{\partial u \partial v} {\vert}_{{u = 0}_{v = 0}} \\ {Θ}_{i} = {Φ}_{i} ( 1 , 1 ) \\ {Θ}_{i}^{u} = \frac{\partial {Φ}_{i} ( u , v )}{\partial u} {\vert}_{{u = 1}_{v = 1}} \\ {Θ}_{i}^{v} = \frac{\partial {Φ}_{i} ( u , v )}{\partial v} {\vert}_{{u = 1}_{v = 1}} \\ {Θ}_{i}^{u , v} = \frac{{\partial }^{2} {Φ}_{i} ( u , v )}{\partial u \partial v} {\vert}_{{u = 1}_{v = 1}} \\ ( i = 1 , 2 , 3 )\end{matrix}$$

Therefore, the constraint equations for position and tangential continuity are given as
6(Ωᵢ−Λ)−6Λᵢ+2Ωᵢ^{v}=−(Λ_{i,i+1}+Λ_{i+1,i+2})
2(Ωᵢ−Λ)−Λᵢ+Ωᵢ^{v}=0
Λ₁+Λ₂+Λ₃=0
(i=1,2,3)
A symmetric solution can be obtained for the above equations:

$$\begin{matrix}Λ = \frac{1}{3} ( {Ω}_{1} + {Ω}_{2} + {Ω}_{3} ) + \frac{1}{6} ( {Ω}_{1}^{v} + {Ω}_{2}^{v} + {Ω}_{3}^{v} ) \\ {Λ}_{i} = 2 {Ω}_{i} + {Ω}_{i}^{v} - \frac{2}{3} ( {Ω}_{1} + {Ω}_{2} + {Ω}_{3} ) - \frac{1}{3} ( {Ω}_{1}^{v} + {Ω}_{2}^{v} + {Ω}_{3}^{v} ) \\ {Λ}_{i , i + 1} = - 6 {Ω}_{i} - 4 {Ω}_{i}^{v} + 2 ( {Ω}_{1} + {Ω}_{2} + {Ω}_{3} ) + \frac{3}{2} ( {Ω}_{1}^{v} + {Ω}_{2}^{v} + {Ω}_{3}^{v} ) \\ ( i = 1 , 2 , 3 )\end{matrix}$$

With all those information, three bicubic Hermite patches can be generated which can be converted to bicubic Bezier surfaces as follow,
Φᵢ(u, V)=(B_{0,3}(u)B_{1,3}(u)B_{2,3}(u)B_{3,3}(u))ACᵢA^{T}(B_{0,3}(v)B_{1,3}(v)B_{2,3}(v)B_{3,3}(v))^{T}
,(i=1,2,3)
where

$$\begin{matrix}A = ( \begin{matrix}1 & 0 & 0 & 0 \\ 1 & 0 & \frac{1}{3} & 0 \\ 0 & 1 & 0 & - \frac{1}{3} \\ 0 & 1 & 0 & 0\end{matrix} ) \\ {C}_{i} = ( \begin{matrix}Λ & {Ω}_{i} & {Λ}_{i} & - {Ω}_{i}^{v} \\ {Ω}_{i - 1} & {Θ}_{i} & {Ω}_{i - 1}^{u} & {Θ}_{i}^{v} \\ {Λ}_{i - 1} & {Ω}_{i}^{u} & {Λ}_{i - 1 , i} & {Ω}_{i}^{u , v} \\ {Ω}_{i - 1}^{u} & - {Θ}_{i + 1}^{u t} & - {Ω}_{i - 1}^{u , v} & {Θ}_{i}^{u , v}\end{matrix} )\end{matrix}$$

1.2.3. Inner and Outer Surfaces

When internal and external walls are desired, the procedure is performed twice, with the given internal and external wall thickness values. When rendering the human vasculature, the outer surface is displayed. When navigating an endovascular system, however, the inner surface is used.

2.0 Pathological Vasculature Modeling

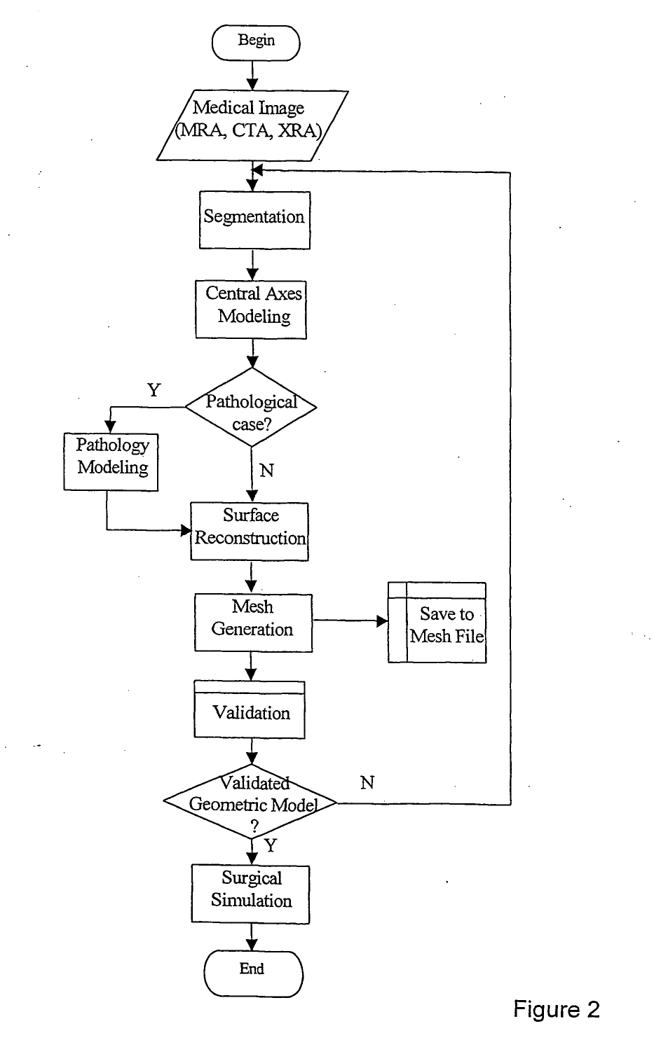

With reference to FIG. 2, where the central axes model includes pathological information, pathological modeling is required. Pathology is very complex and highly patient dependent. It is difficult to model pathology for patient-specific data in a uniform way.

2.1 Weighting

According to an embodiment of the present invention, one modeling approach is to add some weights in the reconstruction procedure according to the description of the pathological information in order to simulate the pathology. According to the pathology shape, some appropriate weights are chosen to modify the normal shape to the pathology shape. In general, it can be described as:
P(\overline{v})=W(\overline{u})·S(\overline{v});
where W(\overline{u}) is the weights function, S(\overline{v}) is the normal geometrical surface representation of the anatomical structure, \overline{v} represents any points at the surface and \overline{u} is the parameter relating to \overline{v}.

In the view of image processing, the weights function can be regarded as a filter, then the modeling means a filtering process. In this regard, it is to choose the appropriate filter whose wave shape is similar to the pathology. A number of filters may be designed as the weights function in the modeling. Wherein some distribution functions may be used to design an appropriate filter for the weights function, such as Gaussian distribution, Beta distribution, gamma distribution, and so on.

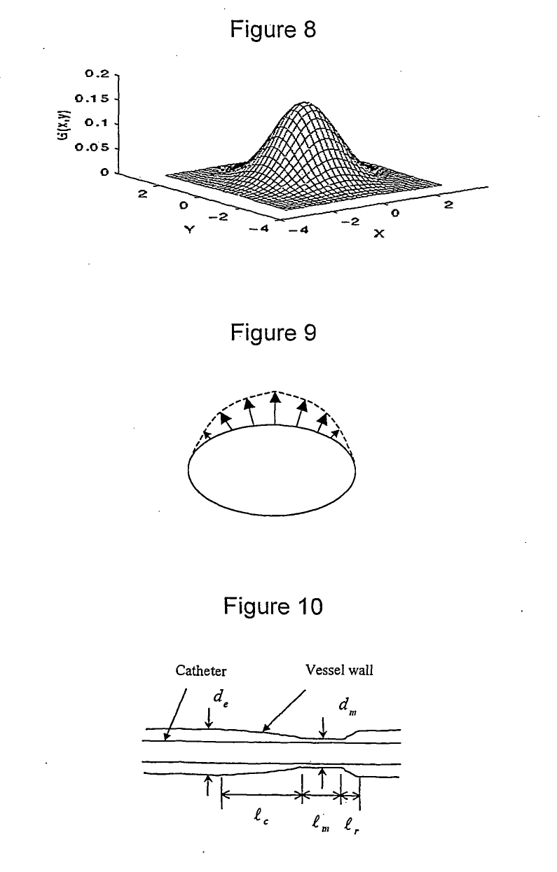

For instance, where the pathology is a bulbous structure, such as a tumour or an aneurysm, a Gaussian filter can be chosen as the weights to describe the pathology. The Gaussian function in polar coordinates is:

$$G ( r , θ ) = {R}_{0} {ⅇ}^{- \frac{{r}^{2}}{2 {σ}^{2}}} ,$$

where R₀ is the maximum distance from the original surface to deformable position and σ is decided according to the shape of the deformation surface. A two-dimensional Gaussian function with zero mean is shown in FIG. 8. By choosing suitable weights and adjusting some parameters, this method is effective for most pathology cases.

For example, adopting the filter

$$W ( r , θ ) = 1 + {R}_{0} {ⅇ}^{- \frac{{r}^{2}}{2 {σ}^{2}}} ,$$

in the point of vascular wall growing an aneurysm P₀, R₀=1 means the distance from the point to the skeleton is 2 times of the former, and σ=1.5, at the next point P₁ where P₀P₁=2, that is r=2, then the weight is calculated as 1.4 which means the point P₁ will grow outward to the point of 1.4 times of the distance to the skeleton.

Once a representation of the relevant pathology has been constructed as such, it may be combined with the central axes model before undergoing surface reconstruction as described above.

2.2 Growing of Pathology

According to another embodiment of this invention, an alternative approach is to simulate the growing of pathology by building a model to simulate the growing procedure.

FEM (Finite Element Method) analysis is a typical method used to build the model. According to the growing routine of pathology, an FEM model is set up first. Then a force is added at the point to simulate the growing procedure of pathology. Through FE computing, the force at each vertex in the surface is calculated. The procedure of mesh generation for Finite Element Analysis is discussed below in Section 3.0.

This method requires surface meshes to be generated first, but is able to describe most pathology models. This pathology growing method is more complex than the weighting approach just described, but nevertheless, an advantage of this method is its generality.

Considering the example of an aneurysm, the FEM model is built according to the forming of aneurysm in blood vessels. The aneurysm may commence to grow when the vascular wall cannot stand the pressure of blood flow. First the area for the aneurysm growing is decided as the FEM analysis area, where the distribution of blood flow force can be observed as well as the physical property of the vessel wall. With the FEM meshes of the area, the deformation of the vascular wall can be computed step by step. When the vascular wall bulges, blood flow goes along the inner vascular wall and the distribution of the blood flow may be observed and recorded for the FEM analysis. This step iterates until the aneurysm grows to the maximum limit.

With the FEM model set up, it may be used to simulate pathology by generating appropriate surface shape changes. Therefore, the growth for different pathological cases may be controlled. In this regard, FIG. 9 shows the growing of a pathological part, being in this instance a tumour. Each vertex in the surface “grows” outward.

2.3 Interactive Modeling

Another method according to this invention allows pathology shapes to be modified interactively. Interactive modeling of pathology provides users with a tool with which they can readily modify the pathological shape as desired. For example, once the pathology has been incorporated into the central axis model, and surface reconstruction performed, a user can pick up a point on a vascular surface of the reconstructed model with a mouse, and then draw the point to the desired place. This deformation is effected by determining the one or more segments that have been altered, and with the new positional information, performing segment reconstruction again on the altered segments.

Aneurysms and stenoses are examples of pathological parts of the human vasculature that may be modeled.

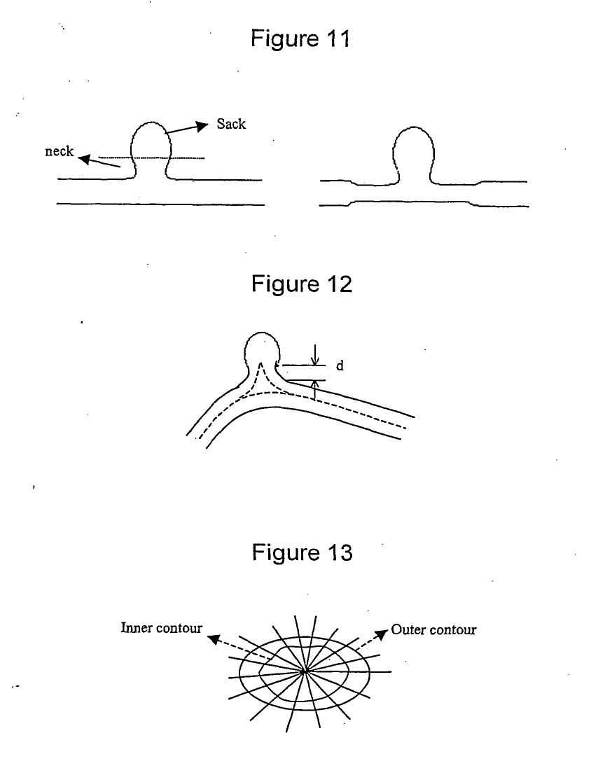

In modeling aneurysms, there are nonstented and stented aneurysm models of the parent artery harboring the aneurysm, which are shown in FIG. 11. FIG. 11 also illustrates the two main parts of an aneurysm, the sack and neck.

The current standard in several commercial systems is to approximate an aneurysm by a sphere, which is not accurate for most-clinical cases. In the present embodiment of the invention, the aneurysm will be modeled using the sack and neck.

In this regard, an elliptical cylinder can approximate most aneurysm necks. The length of the cylinder for the neck is usually varies, depending upon specific patient data. It can be chosen as a major geometric parameter for the models. Another geometric parameter that may be chosen is the radii of the cylinder.

The sack of aneurysms can be approximated by an ellipsoid, which is connected onto the neck. The joint modeling process discussed in 1.2 above, can be readily applied to the method of reconstructing the aneurysm. That is, in reconstructing the aneurysm, we regard the neck of the aneurysm as one branch, which forms a joint with the parent artery harboring the aneurysm. Therefore, referring to FIG. 12, in the reconstruction of aneurysms, we first connect the neck to its parent artery using the method of joint modeling, then reconstruct the sack independently. To construct the sack, the characteristic parameters of the ellipsoid should be chosen as representations of geometric information.

The aneurysm may also be represented by extracting the central axis as a part of the whole central axis model. This approach can facilitate the device/vessel interaction and modeling of embolisms. The measuring of aneurysm volume is also an important factor. This can be done using a numerical integration method, whereby the aneurysm is sliced into many cross-sections along the central axis and then the volume between every two adjacent cross-sections computed and summed.

To analyze stenotic vessel segments, their shape both before and-after angioplasty needs to be modeled. In this regard FIG. 10 shows a typical stenosis after angioplasty.

An example of how the changes in shape are compared will now be described in regard to lumen shape data obtained from a particular clinical investigation for a proximal left anterior descending coronary artery stenosis from a patient angiogram before PTCA (Percutaneous Transluminal Coronary Angioplasty) after the first balloon inflation, and after the final balloon inflation. In this case the minimal lesion diameter dₘ=0.95 mm before angioplasty was increased to dₘ=1.80 mm after final balloon inflation. The data traced from the angiograms with vessel diameters measured every 0.25 mm along the vessel segment indicated that the effect of balloon dilation was to axially redistribute the plaque away from the narrowest cross-sectional area to a length Em of about one proximal vessel diameter, i.e., lₘ≈dₑ. The length of the constriction vessel portion l_{c}≈2dₑ. There was rather abrupt vessel divergence downstream of the end of the narrowest portion so that the length of this segment lᵣ=0.5dₑ. In this case, both the proximal and distal vessel segment diameters were also increased after the procedure, but the magnitude of the changes in dₑ in particular was larger than usually observed.

These angiographic observations provide the geometric parameters from which the stenosis can be constructed. The stenosis geometric parameters can be incorporated in the central axis model, and then, in the surface reconstruction, construct it through the segment modeling. Users are then able to change the parameters of the constructed pathology in the resulting model in order to interactively modify the shape.

3.0 Mesh Generation for Finite Element Analysis

In an interventional procedure, an FEM model may be used to analyze the behavior of a vascular wall in a collision with a catheter. Though commercial mesh generation software packages are available nowadays, they are often expensive and generally do not offer the flexibility of specially designed programs. Hence, according to an embodiment of the present invention, a dedicated 3D mesh generator is provided for FEM analysis in the simulation system. With the central axes model, this generator may be used to generate 3D meshes quickly.

Meshing is the process of breaking up a physical domain into smaller sub-domains. There are various types of meshing, including 2D meshing, 3D meshing, and surface meshing.

The automatic mesh generation problem involves attempting to define a set of nodes and elements that best describe a geometric domain, such that the geometry may be composed of vertices, curves, surfaces and solids. Many applications first mesh the vertices, followed-by curves and then the surfaces and solids. Therefore, nodes are first placed at all vertices of the geometry and are then distributed along geometric curves. In turn the result of the curve meshing process provides input to a surface-meshing algorithm. The meshing process then composing the surface into well shaped triangles or quadrilaterals. Finally, if a 3D solid is provided as the geometric domain, a set of meshed areas defining a closed volume is provided as input to a volume mesher for formation of tetrahedra and/or hexahedra.

In the present invention, for a simple FEM analysis, 3D meshes are generated as 8-noded elements. The algorithm consists of three steps: 2D meshing, 3D meshing and refinements. The 2D meshing step generates 2D meshes at each cross-section with a gridding algorithm. As the thickness of the vascular system is very small, the gridding scheme can be simplified like the polar diagram shown in FIG. 13.

Along the radius direction, it is divided equally. The resolution of the gridding is decided by the distance of two neighboring points on the edge contours. The approach generates nearly equilateral 8-noded elements, which is sufficient for FEM analysis. The node and the elements are then numbered to generate 2D meshes at the cross-section. In the numbering algorithm, the topology must be kept consistent for all the 2D meshes.

In order to generate efficient FEM meshes, an optimization process may be undertaken to refine the 2D meshes.

The next step involves connecting the 2D meshes at two adjacent cross-sections to generate 3D meshes. In this regard the corresponding points at any two adjacent cross-sections are connected, which forms many small hexahedrons. In the connection, severe distortion of the element shape is undesirable. This distortion may occur when the nodes of an element surface do not share the same plane. Therefore a consistent gridding system is adopted to avoid the distortion, which strictly aligns the gridding of two adjacent cross-sections in the same orientation and with the same gridding resolution. Then the volume meshes are generated by joining the corresponding points at the grid of two adjacent cross-sections.

The area between two adjacent cross-sections may also need to be subdivided according to the resolution of the 2D mesh at the cross-section, to form one or more additional points between two adjacent cross-sections to include in the interconnection process, which generates more standard finite element meshes for FEM analysis. It can be done by interpolating cross-sections between two adjacent cross-sections, then generating 3D meshes with the mesh generation method.

An important concept in FEA is the number of elements in the mesh model. This parameter is crucial to the accuracy of the analysis, as the accuracy increases as the number of elements is increased. Here the Bezier surface curve representation allows the creation of new vertices at arbitrary distances on the boundary. The algorithm described above can thus generate meshes of arbitrary refinement.

After generating the 3D mesh, the correctness of the finite element mesh and mesh properties should be analyzed in order to ensure effective FEM analysis. For mesh verification, computational procedures can be used to compute Jacobians, aspect ratios, volumes and areas of elements. These can then be used to optimize and refine any inaccuracies in the finite element mesh.

This mesh generation procedure is designed to be well integrated with the geometrical modeling. It can also generate 3D FEM meshes to save in a file for later FEM analysis.

3D surface meshes can also be generated using FEM analysis. This approach may be utilized in the visualization procedure, where it is only necessary to visualize the surface with surface meshes, so complete 3D meshing is not required. In this regard, the boundary elements are firstly selected from the finite elements, then surface patches are extracted from the boundary elements.

4.0 Validation & Analysis of Geometric Modeling

There is a need to validate the geometrical models constructed from the initial volume images. In the present invention there are two possible types of models:
i) a model for computing deformation; and
ii) a model for graphical rendering.
   These models are different because of their different roles, although they are representations of the same object.

More specifically, the model for computing deformation usually consists of eight-node elements for finite element computation, and may be optimized for computation and traded off in relation to visual details. However, for the model used in graphical rendering, it is of utmost importance to have smoothness and be visually appealing. The performance of the later model depends on the performance of the processing computer's graphic card while the former depends mainly on the raw processing power of its CPU.

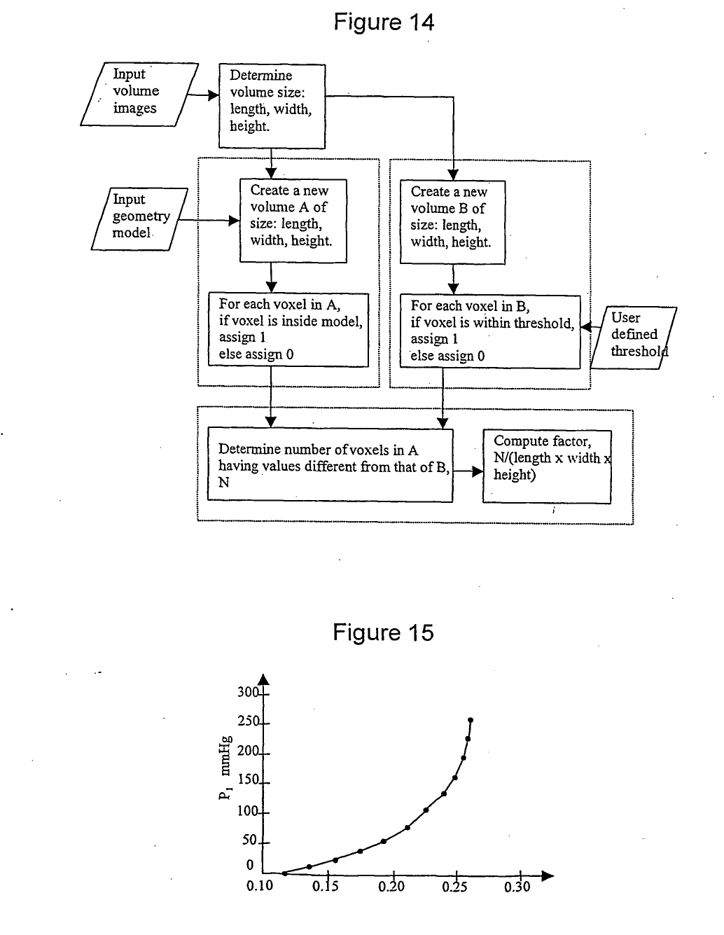

The flowchart illustrated in FIG. 14 shows a process, according to an embodiment of the present invention, of validating the generated geometrical models from the volume images. There are three main tasks.

The first task, called Binary Volume Generation, is used to construct a volume with values 1 (or black) assigned to voxels defining the geometrical model while 0 (or white) for all other voxels. In this regard, the volume is preferably constructed using parameters of the original volume images from which the geometrical model was created. For example, volume size, length, width and height can be extracted from the volume images and the corresponding binary volume that is created will have the same volume size, length, width and height.

Independent of the first task, the second task is to generate another binary volume from the volume images using thresholding. That is, the user defines a threshold, and a binary volume is constructed, also using the parameters of the original volume images, whereby each voxel within the threshold is assigned the value 1, while all other voxels are assigned 0. In our embodiment, we define threshold as the highest intensity value of a voxel to be classified as a part of the targeted anatomical structure. For example, we used a value of 75 as a threshold to target human cerebral vascular in an 8-bit volume data set. The threshold could vary depending on the scanning parameters. We may use an intensity range instead of a single value threshold. In this case, the voxel whose intensity falls within the range is assigned the value of 1, while all other voxels are assigned 0.

The third task compares the binary volume of the model with the binary volume of the volume images. This is preferably achieved by dividing the number of voxels having different values with the total number of voxels. This fraction should approach zero for an accurate model.

4.1 Multi-Functional Visualization in a Simulation Environment

Visualization is a fundamental component in virtual reality simulation environments. For example, a system embodying the present invention may provide a versatile visualization function, which includes 3D rendering of a human vascular system, real-time display of catheterizing procedure in blood vessels, and virtual endovascular navigation.

4.1.1 3D Rendering of Human Vasculature

Based on the surface reconstruction, a 3D rendering may be achieved in various ways. In this regard, the 3D rendering could include a display of the central axes, wire frame, cross-contours, meshes and/or a shaded surface. The 3D rendering would provide a rotational 3D overview of the object and different scaling.

4.1.2 Real-Time Display of Catheterizing Procedure in Blood Vessels

Simulation of the catheterizing procedure, may be achieved in several ways. One way is to use a transparent mode, in which the surface of the human vascular network can be seen and the central axes penetrating through the surface. The catheter would stretch along the central axes, and preferably be displayed in a different color.

Another approach is to render the vascular system only with its central axes visible, and with the catheterizing procedure rendered along the central axes.

4.1.3 Virtual Endovascular Navigation

To implement the examination procedure of intravascular systems, it is necessary to provide a virtual endovascular navigation function. Considering the fact that anatomical structures commonly found in patient datasets are very complex, even for a specifically trained physician, it can be difficult to navigate to the target. Furthermore, collision avoidance is a costly operation, which is frequently not available in most virtual endoscopy applications.

Therefore, in order to implement full flexibility, combined with user guidance, and an efficient collision avoidance scheme, an interactive guided-navigation paradigm may be provided, whereby while navigating an endovascular system, the central axes is used to guide a virtual camera. Also, the distance from the central axes to the inner surface is used to analyze collision avoidance.

4.1.4 Visualization of Finite Element Analysis

In the navigation of the catheter, the behavior of the collision when the catheter contacts with the inner wall of the vascular network needs to be simulated. Generally, two deformations-occur in this collision: one is the wall of the vascular network, the other is the composite effect on the guide wire and catheter. Based on a specific FEM model (such as one where the blood vessels are stretched by surrounding muscles which are hardly deformed and having the tip of a guide wire or navigation catheter which is very soft), it is possible to analyze and visualize this deformation simultaneously.

Additionally, the FEM plays a role in the simulation of interaction between cardiovascular devices and the vasculature. In this regard, angioplasty devices are brought to the placement location through simulated catheter navigation. The balloon inflation may be simulated as a tank structure expanding uniformly. Detection of collision is then implemented through the interaction of this structure with the applicable blood vessel segment represented as a generalized cylinder. The stent release may be simulated as a simplified procedure of displaying a piece of tube on the inner surface of the vessel segment.

4.1.5 Registration of Surface and FEM Meshes

FEM analysis of, for example, catheterization is computational costly. For computational efficiency, the 3D meshes surrounding the catheter tip are focussed upon. This is a valid assumption since the tip end of catheter and surrounded vessels are the focus of the procedure.

The registration of surface and FEM meshes will solve the problem of locating the corresponding FEM meshes while visualizing the insertion of catheter in blood vessels. With the Central Axes Model, it is not difficult to do this-by first locating the applicable part of the central axes, and then obtaining the local part of the 3D meshes mapping the applicable part of central axes. This reduces the computation to a smaller data set. According to the central axes, it is then possible to map the surface meshes and FEM meshes. Hence, the behavior of catheter insertion and navigation, and the visualization of the vascular network correspond.

Variations and additions are possible within the general inventive concept as will be apparent to those skilled in the art.

In this regard, it is to be appreciated that components of the modeling procedure according to the present invention may be used in other areas. For example, the surface reconstruction procedure could be used in computer-aided design and other scientific visualization applications. Also, once the geometric model is validated, it may be implemented in a multi-functional visualization for a simulation environment.

In addition, the geometric modeling of the present invention may be used to undertake pathological diagnosis. By combining the geometric modeling of the present invention and some characteristics of pathological cases, it is possible to undertake pathological diagnosis by analyzing the geometric modeling of human anatomy. For example, in vascular networks, the abnormal vessels have very distinct geometrical features compared to normal vessels. Therefore, by analyzing the geometrical model of a vascular system it may be possible to identify pathological cases directly. In this regard, it is apparent that radii and curvatures of vascular networks are two characteristic parameters, so by identifying the radius and curvature along the skeleton of vasculature, it is possible to recognize pathological cases.

1. In a biomedical simulation environment, a method of forming a visually continuous surface across a joint of a plurality of anatomical branches, the method including the steps of:
generating surfaces for the anatomical branches using a part-surface sweeping operation; and
constructing surfaces across any holes in the surface across the joint using a patch filling method to complete the joint surface.

2. Method of claim 1 wherein the surfaces are generated by:
determining an appropriate cross-section for each branch;
dividing the cross-sections into portions, such that each portion is associated with a corresponding portion of a neighboring branch;
performing the part-surface sweeping operation along a trajectory relating to each of the associated portions.

3. Method of claim 2 wherein the trajectories are generated using a cubic Bezier curve, and include the steps of:
generating branch trajectories through vertices of each branch;
determining at least one control point on each branch trajectory;
forming a cubic Bezier curve between each set of neighbouring branches using the at least one control point relating to each branch.

4. Method of claim 2 wherein the part-surface sweeping operation is performed using moving trihedron modelling.

5. Method of claim 4 wherein the moving trihedron modeling includes the following steps:
initiating a trihedron (Tᵢ⁰, Nᵢ⁰, Bᵢ⁰) at an end of the trajectory with parameter t=0, such that T, N and B are unit tangent, normal and binormal vectors of the trajectory at a given point, respectively;
projecting a vector Bᵢ⁰ onto the plane defined by tangent vector Tᵢ¹ with parameter t=⅓, in order to obtain a new vector Bᵢ¹=Bᵢ⁰−(Bᵢ⁰•Tᵢ¹)Tᵢ¹;
calculating vector Nᵢ¹ as the cross-product of Bᵢ¹ and Tᵢ¹;
projecting the vector Bᵢ¹ onto the plane defined by tangent vector Tᵢ² with parameter t=⅔ in order to obtain a new vector Bᵢ²=Bᵢ¹−(Bᵢ¹•Tᵢ²)Tᵢ²;
calculating vector Nᵢ² as the cross-product of Bᵢ² and Tᵢ²;
projecting the vector Bᵢ² onto the plane defined by tangent vector Tᵢ³ with parameter t=1 in order to obtain a new vector Bᵢ³=Bᵢ²−(Bᵢ²•Tᵢ³) Tᵢ³;
calculating vector Ni³ as the cross-product of Bᵢ³ and Tᵢ³.

6. Method of claim 5 wherein (Tᵢ³, Nᵢ³, Bᵢ³) is used as the new start trihedron for trihedron (Tᵢ₊₁⁰, Nᵢ₊₁⁰, Bᵢ₊₁⁰).

7. Method of claim 2 wherein the construction of surfaces across any holes includes the steps of:
dividing each Bezier curve of each branch surface in two on the boundary with the hole at a particular point;
determining a center vertex of the hole;
dividing the hole into a plurality of subpatches, using the particular points and the center vertex, the number of depending upon the number of branches; and
constructing a surface across each subpatch.

8. In a biomedical simulation environment, a method of constructing a surface of a 3D object using a segmented geometrical model, including the steps of undertaking segment reconstruction and joint reconstruction using the segmented geometric model such that the joint reconstruction is in accordance with claim 2.

9. Method of claim 8 wherein the segment reconstruction includes the steps of:
generating a trajectory along a central axis of the geometric model;
conducting moving trihedron modeling along the generated trajectory; and
creating a sweeping surface along the trajectory.

10. Method of claim 9 wherein the trajectory is generated using a piecewise Bezier curve, and further includes the steps of:
creating a tangent node vector for each node of the central axis;
generating at least one control point between each pair of neighbouring nodes using the tangent node vectors of the applicable pair of neighbouring nodes;
forming a cubic Bezier curve using the at least one control point.

11. Computer program product including a computer usable medium having computer readable program code and computer readable system code embodied on said medium for constructing a surface on a virtual geometric anatomical model, said computer program product further including computer readable code within said computer usable medium for:
undertaking the method according to claim 1.

12. In a biomedical simulation environment, a method of pathological modeling for use in the simulation of the growth of a pathology, the method including:
creating a 3D surface model of the pathology;
applying outward force at one or more surface points of the model; and
calculating the degree of each force and the degree of deformation of the model at the one or more surface points as a result of each force.

13. In a biomedical simulation environment, a method of pathological modeling for use in the simulation of the growth of a pathology, the method including:
creating a 3D surface model of the pathology;
applying an appropriate weight function to the model, the weight function relating to the shape of the pathology being modeled.

14. Method of claim 13 wherein the pathology is a tumor or aneurysm and the weight function applied is a Gaussian filter.

15. Method of claim 14 wherein the Gaussian filter is
$$G ( r , θ ) = {R}_{0} {ⅇ}^{- \frac{{r}^{2}}{2 {σ}^{2}}}$$
such that R₀ is a maximum deformable position of a point on the model and a relates to the shape of the deformable surface.

16. In a biomedical simulation environment, a method of interactive pathological modeling, the method including:
obtaining angiographic observations relating to a pathology;
extracting geometric parameter bounds relating to the pathology from the angiographic observations;
incorporating the pathological parameters into a geometric anatomical model;
constructing a 3D anatomical model including the pathology from the geometric model such that the shape of the pathology is capable of modification by a user within the geometric parameter bounds.

17. In a biomedical simulation environment, a method of automatically generating FEM mesh on a virtual anatomical object model for use in simulating deformation of at least a portion of the object, the model being formed from a plurality of cross-sections each having a plurality of points on the edges of the cross-sections with edge lengths between adjacent points on each cross-section, the method including the steps of:
undertaking 2D mesh generation at each cross-section; and
undertaking 3D mesh generation between two adjacent cross sections by subdividing edge lengths of each cross-section to form one or more additional points and connecting corresponding points between adjacent cross-sections; and
undertaking mesh refinement and/or optimization of the resultant 3D mesh.

18. Method of claim 17 wherein the 2D mesh generation is undertaken with a flexible resolution.

19. Computer program product including a computer usable medium having computer readable program code and computer readable system code embodied on said medium for generating a mesh on a virtual geometric model for FEM analysis, the model formed from a plurality of cross-sections each having a plurality of points on the edges of the cross-sections with edge lengths between adjacent points on each cross-section, said computer program product further including computer readable code within said computer usable medium for:
undertaking 2D mesh generation at each cross-section; and
undertaking 3D mesh generation between two adjacent cross sections by subdividing edge lengths of each cross-section to form one or more additional points and connecting corresponding points between adjacent cross-sections; and
undertaking mesh refinement and/or optimization of the resultant 3D mesh.

20. Method of automatically generating a surface mesh on a object model for use in FEM analysis, the model being formed from a plurality of cross-sections each having a plurality of points on the edges of the cross-sections with edge lengths between adjacent points on each cross-section, the method including the steps of:
undertaking 3D mesh generation between two adjacent cross sections by subdividing edge lengths of each cross-section to form one or more additional points and connecting corresponding points between adjacent cross-sections.

21. Method of validating the accuracy of a geometric model, including the steps of:
generating a first binary volume image relating to the geometric model;
generating a second binary volume image relating to a validation threshold;
comparing the first binary volume image with the second binary volume image in order to obtain an indication relating to the degree of accuracy of the geometric model.

22. Method of claim 21 wherein the step of comparing the first and second volume images further includes determining the number of voxels in the first volume image that have values different from equivalent voxels in the second volume image.

23. Method of claim 22 wherein the indication is a factor achieved by dividing the number of voxels with different values by the total number of voxels, whereby the factor approaches zero for an accurate model.

24. Method of claim 21 wherein the geometric model is constructed from one or more volume images, and the steps of generating the first and second binary volume images utilize a volume model derived from parameters of the one or more volume images.

25. Method of claim 24 wherein the parameters include volume size, length, width and height.

26. In a biomedical simulation environment, a method of constructing a surface of a 3D object using a segmented geometrical model, including the steps of undertaking segment reconstruction and joint reconstruction using the segmented geometric model such that the joint reconstruction is in accordance with claim 1.

27. Computer program product including a computer usable medium having computer readable program code and computer readable system code embodied on said medium for constructing a surface on a virtual geometric anatomical model, said computer program product further including computer readable code within said computer usable medium for:
undertaking the method according to claim 2.
